(19) United States
(12) Patent Application Publication
(10) Pub. No.: US 2010/0187845 A1
(43) Pub. Date: Jul. 29, 2010

(54) SELF-ORIENTING OBJECT-GRASPING DEVICE AND METHOD FOR OBJECT RETRIEVAL AND PLACEMENT

(76) Inventors: Michael W. Larson, Seattle, WA (US); Stephen A. Krippner, Seattle, WA (US); Leonard V. Valdez, Milwaukee, WA (US)

Correspondence Address: OLYMPIC PATENT WORKS PLLC, P.O. BOX 4277, SEATTLE, WA, 98104, US

(21) Appl. No.: 12/692,466

(22) Filed: Jan. 22, 2010

Related U.S. Application Data
(60) Provisional application No. 61/148,194, filed on Jan. 29, 2009.

(51) Int. Cl. B66C 1/44; B66C 1/22; B66C 1/10

(52) U.S. Cl. 294/92; 294/99.1

(57) ABSTRACT

Embodiments of the present invention are directed to self-orienting object-grasping devices that facilitate grasping and raising of objects by individuals. Certain embodiments of the present invention are directed to self-orienting golf-flagpole-retrieving devices that are affixed to flagpoles to allow a golf player to raise the flagpole, using a golf club or similar object, to a height convenient for grasping the flagpole by a golf player.

### CROSS-REFERENCE TO RELATED APPLICATION

This application claims the benefit of Provisional Application No. 61/148,194, filed Jan. 29, 2009.

### TECHNICAL FIELD

The present invention is related to object retrieval and, in particular, to a mechanical self-orienting object-grasping device and method for placing and retrieving objects to which the mechanical self-orienting object-grasping device is affixed.

### BACKGROUND OF THE INVENTION

Mechanical devices have been used, for many years, to ease the physical burdens associated with many tasks. In particular, repetitive tasks that require stooping or bending, from a standing position, or repeatedly bending from a sitting position, may, over time, initiate or aggravate painful physical conditions in those carrying out the repetitive tasks. As one example, a variety of mechanical object retrievers have been developed to assist those picking up trash from parks, sidewalks, roadsides, and other locations in which trash and garbage accumulate. These devices are generally elongated, rod-like devices with handles, at one end, and object-gripping or object-piercing devices at the other end. As another example, elongated screw-driving devices have been developed to allow floor installers to drive wood screws into flooring and decking materials from a standing position, rather than requiring floor installers to crouch and drive wood screws using handheld power drills.

In many cases, individuals are reluctant to stoop, squat, or bend, from a standing position, or bend from a sitting position, in order to retrieve objects lying on the ground due to physical constraints or to the anticipation of pain. As people age, particularly those with various physical conditions and ailments that restrict mobility of joints and/or flexing of muscles, bending and stooping may require increasing effort and may be associated with pain. In other cases, individuals may simply lack the motivation to bend, stoop, squat, or otherwise exert themselves in order to pick up objects that they are responsible for picking up.

Golf provides one example of the inability, or unwillingness, of individuals to retrieve objects laying on the ground. FIG. 1 illustrates a typical golf course setting. In FIG. 1, a fairway 102 leads up to a green 104 in which a hole 106 represents the goal, or target, for a golf ball struck by a club during the game of golf. Golf courses generally include 9, 18, or more fairways and associated greens, generally referred to as “holes,” which are played in sequence. Each player of a group of players, in an order or sequence of players, places a golf ball on a tee at the opposite end of the fairway from the green and strikes the ball with a driver club to initiate play of a hole. Because fairways can extend for several hundred yards or more, and because the hole 106 is flush with the surface of the green and relatively small, a flagpole, to which a brightly colored flag, or pennant 110 is attached, is normally inserted into the hole 106 to mark the position of the cup within the green for golfers hundreds of yards away, at the beginning of the fairway and at intermediate points along the fairway. The flagpole and pennant remain inserted into the cup until the players have managed to position their balls on the green, from which positions the players can readily see the hole. The flagpole should then generally be removed from the cup and gently laid onto the surface of the green, to avoid damaging the green, to allow the golf players to putt their golf balls into the hole using putter clubs, unobstructed by the flag pole. Unfortunately, golfers who are not motivated or are unable to bend to lay the flagpole onto the surface of the green may instead drop the flagpole from waist height, risking damage to the green. FIG. 2 illustrates the flagpole and attached pennant laying on the green near the hole, following removal of the flagpole.

Once all the golfers in a group of golfers have sunk their balls into the hole, a golfer from the party is required, by course rules, obligated by etiquette, or both required and obligated to pick up the flagpole and attached pennant from the green and reinsert the flagpole, in an upright position, into the hole, so that a next group of golfers can aim their shots from the beginning of the fairway and from intermediate points along the fairway; without walking hundreds of yards from the beginning of the fairway to replace the flagpole removed by the preceding party.

Thus, flagpoles are frequently removed and replaced during golf play. For patient and healthy golfers, flagpole replacement is a routine task. However, for golfers with physical ailments or constraints and for certain golfers lacking patience, retrieving flagpoles from the surface of the greens can be a difficult, painful, and/or onerous task.

### SUMMARY OF THE INVENTION

Embodiments of the present invention are directed to self-orienting object-grasping devices that facilitate grasping and raising of objects by individuals. Certain embodiments of the present invention are directed to self-orienting golf-flagpole-retrieving devices that are affixed to flagpoles to allow a golf player to raise the flagpole, using a golf club or similar object, to a height convenient for grasping the flagpole by a golf player and that may also allow a player to lower the flagpole, using a golf club or similar object, from a height convenient for grasping the flagpole to the ground.

### BRIEF DESCRIPTION OF THE DRAWINGS

FIG. 1 illustrates a typical golf course setting.

FIG. 2 illustrates the flagpole and attached pennant laying on the green near the hole, following removal of the flagpole.

FIGS. 3A-D illustrate use of a self-orienting flagpole-grasping device by a golf player.

FIGS. 4A-B illustrate an unassembled flagpole-grasping device that represents one embodiment of the present invention.

FIG. 5 shows an assembled flagpole-grasping device that represents one embodiment of the present invention, shown in unassembled form in FIGS. 4A-B, affixed to the end of a golf course flagpole.

FIGS. 6A-B illustrate the self-orienting property of the flagpole-grasping device that represents one embodiment of the present invention.

FIG. 7A shows an alternative flagpole-grasping device that represents a second embodiment of the present invention.

FIGS. 7B-D illustrate the self-orienting properties of the flagpole-grasping device that represents a second embodiment of the present invention.

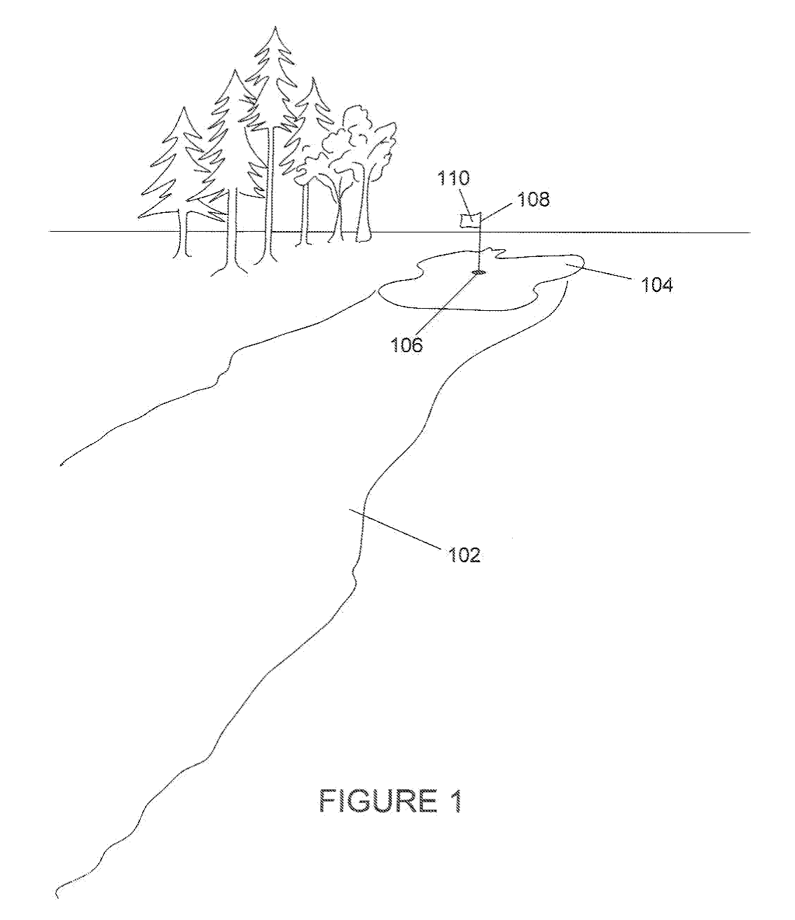

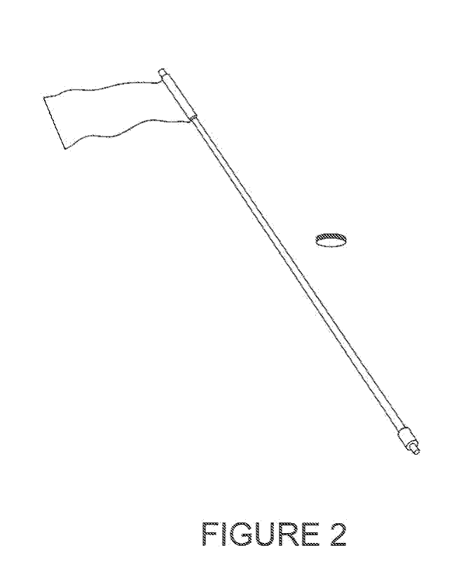

### DETAILED DESCRIPTION OF THE INVENTION

Embodiments of the present invention are directed to self-orienting retrieval devices that grasp a manually positioned probe or retriever to allow an individual to raise an object, to which the self-orienting object-grasping device is affixed, to a level where the object can be manually grasped, held, and manipulated by the individual, without requiring the individual to stoop, bend, crouch, or squat from a standing position in order to grasp the object. Particular embodiments of the present invention are directed to self-orienting flagpole-grasping devices that are affixed to the end of a flagpole to allow a golfer to grasp the flagpole, via the flagpole-grasping devices, with a golf club in order to raise the flagpole to a level where the golfer can manually grasp, hold, and manipulate the flagpole. A self-orienting flagpole-grasping device may be affixed to a flagpole to which a pennant is attached to mark a hole in a golf course so that, when the flagpole is removed by a player and laid onto the surface of a green, to facilitate putting golf balls into the hole, a player can subsequently use his or her putter club to raise and grasp the flagpole lying on the green without crouching, bending, squatting, or other physical movement that might cause pain or exacerbate many of various physical conditions and ailments, or without expending physical effort that represents an obstacle to replacing the flagpole. In addition, by a complementary method, a golf player can use the flagpole-grasping device to lower a flagpole from waist height to the green to avoid damaging the green by inserting a golf club into the flagpole-grasping device and then lowering the golf club.

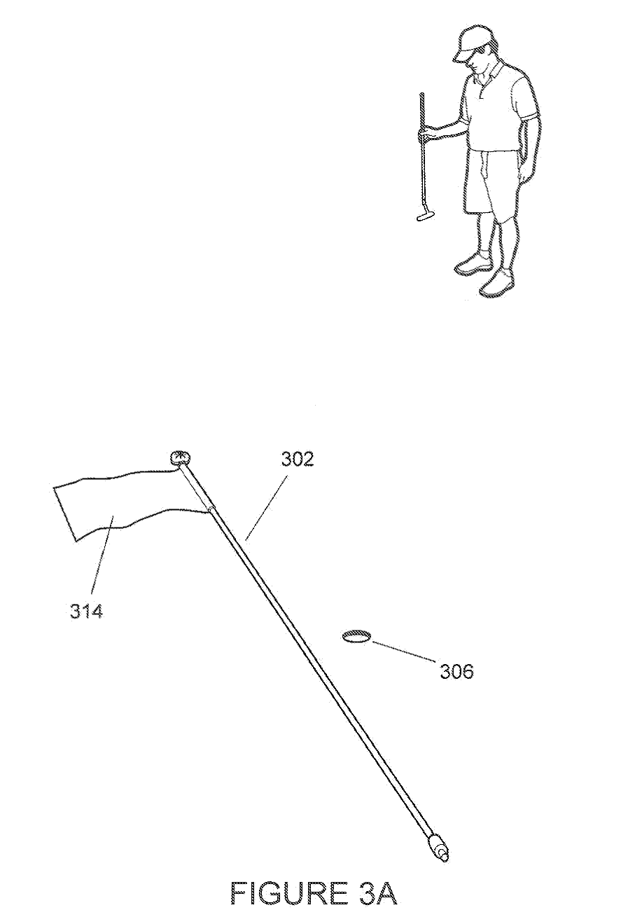

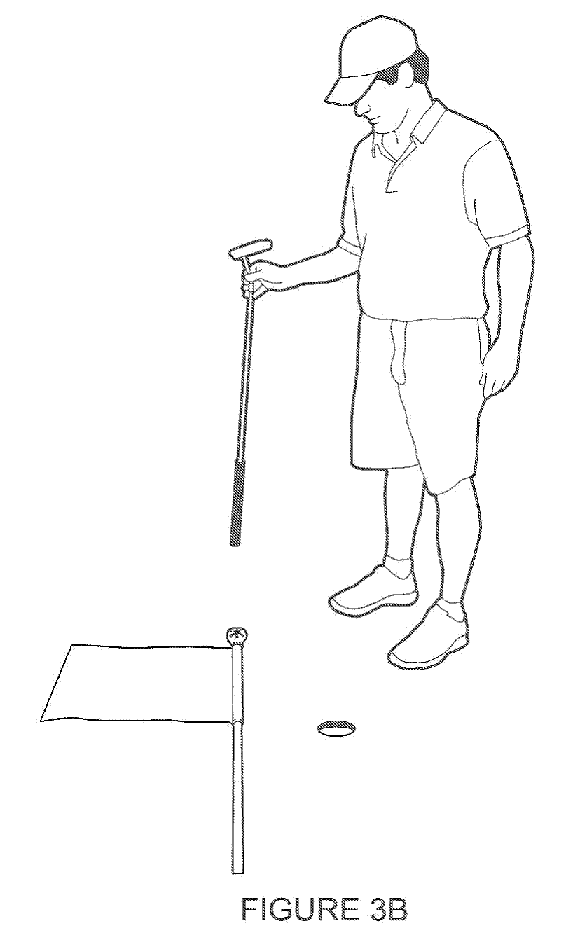

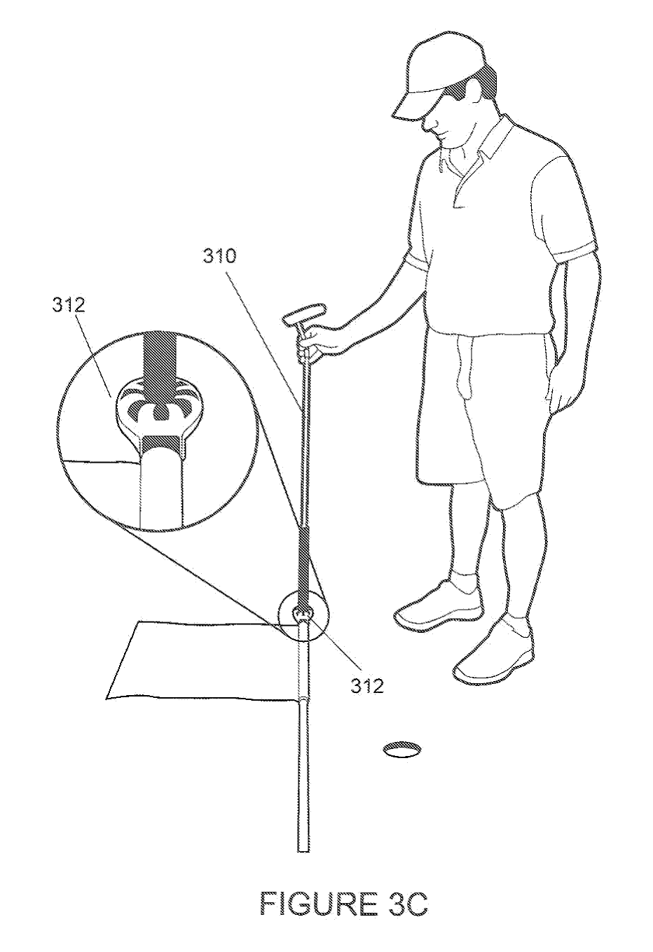

FIGS. 3A-D illustrate use of a self-orienting flagpole-grasping device by a golf player. In FIG. 3A, a flagpole 302 with attached pennant 304 has been laid on a green, next to a golf hole 306, to facilitate putting, by the player, of a golf ball into the hole 306. After play at the hole is finished, the golfer walks over to the flag-attached end of the flagpole, as shown in FIG. 3B, and inserts the handle of his golf putter 310, as shown in FIG. 3C, into a flagpole-grasping device 312, affixed to the end of the flagpole and representing one embodiment of the present invention, in order to lift the flagpole from the ground. As shown in FIG. 3D, the golfer then raises the flagpole 302 by lifting the putter now firmly grasped by the flagpole-grasping device 312 that represents one embodiment of the present invention. The golfer has managed to remain in the standing position, without stooping, bending, crouching, or squatting to retrieve the flagpole. The player can then reinstall the flag pole in an upright position to mark the hole for a next party of golfers.

As discussed above, many types of mechanical lifting and object-retrieval devices have been developed, over the past several centuries, to facilitate a variety of manual grasping and lifting tasks. However, these devices are generally unsuitable for flagpole retrieval. Retrieval of flagpoles from golf greens is associated with a number of constraints that are generally not associated with other manual lifting and object-retrieval tasks, such as picking up trash or general retrieval of dropped objects. One constraint associated with retrieval of flagpoles from golf greens is that the flagpole-grasping device and the retrieval operation need to be designed to prevent damage to the green surrounding a hole, or cup, on which the flagpole is generally laid prior to the cutting phrase of the golf game. Greens are generally carefully maintained to provide smooth surfaces on which rolling-golf-ball trajectories are predictable and regular. Use of mechanical devices that, when dropped or deployed, dig up grass or create depressions or holes in the green is undesirable. The flagpole-grasping device needs to be attached to the flagpole, and needs to be designed to be grasped by either the handle end or the club end of a golf club, to facilitate convenient flag-pole retrieval by golfers. The flagpole-grasping device should be economical, simply designed, and simply attached to a flagpole to facilitate deployment of the flagpole-grasping device by golf course personnel. Finally, the flagpole-grasping device needs to be self-orienting, so that, however the flagpole is laid by golfers, the flagpole-grasping device ends up oriented in an orientation that allows a golf club to be lowered, by a golfer, to the flagpole-grasping device and securely grasped by the flagpole-grasping device, without resulting in damage to the underlying green. In addition, it may be desirable for the flagpole-grasping device to attach to a standard threaded fastener, commonly found on the flagpoles used on golf courses. It is also desirable that the flagpole-grasping device can be affixed to the flagpole without use of special tools or operations, to facilitate deployment of the flagpole-grasping device by golf course personnel. In many cases, it is convenient for the flagpole-grasping device to additionally act as a reflective surface to facilitate laser range finding from various points on the golf course.

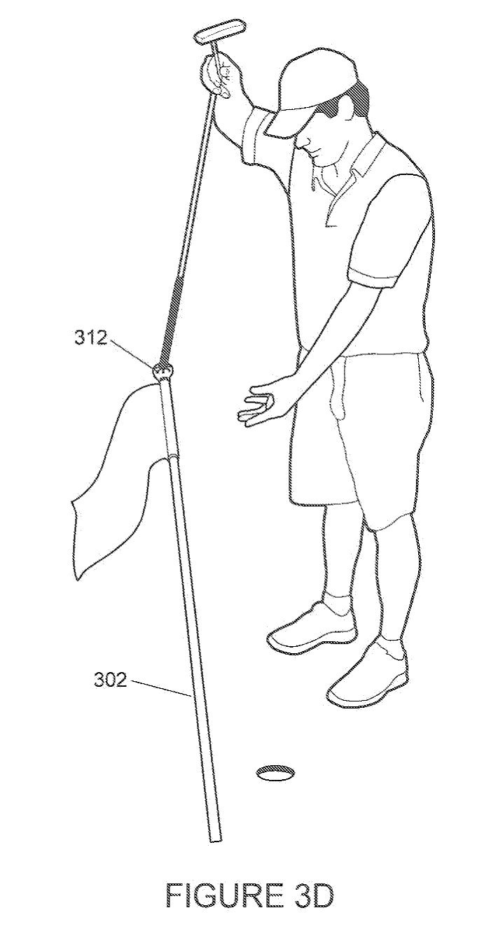

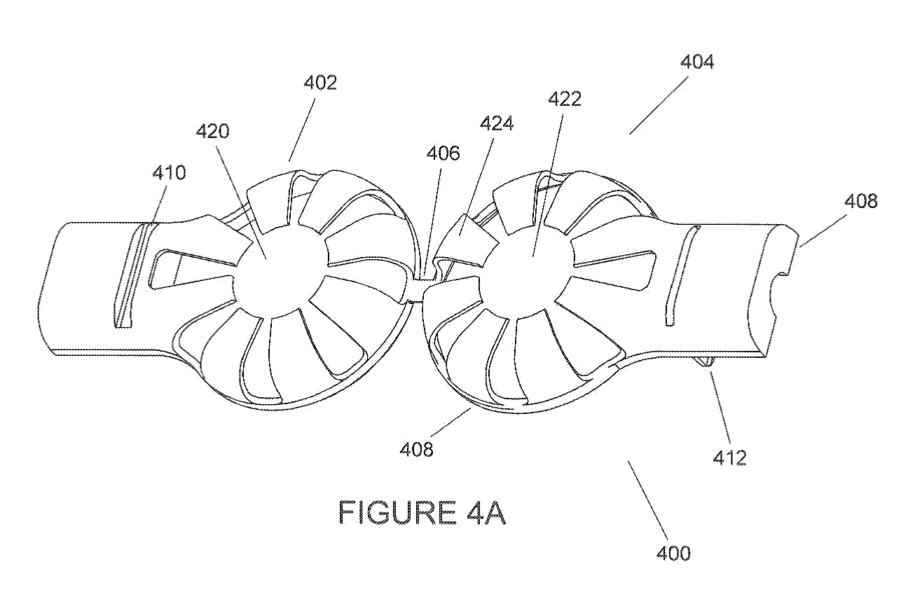

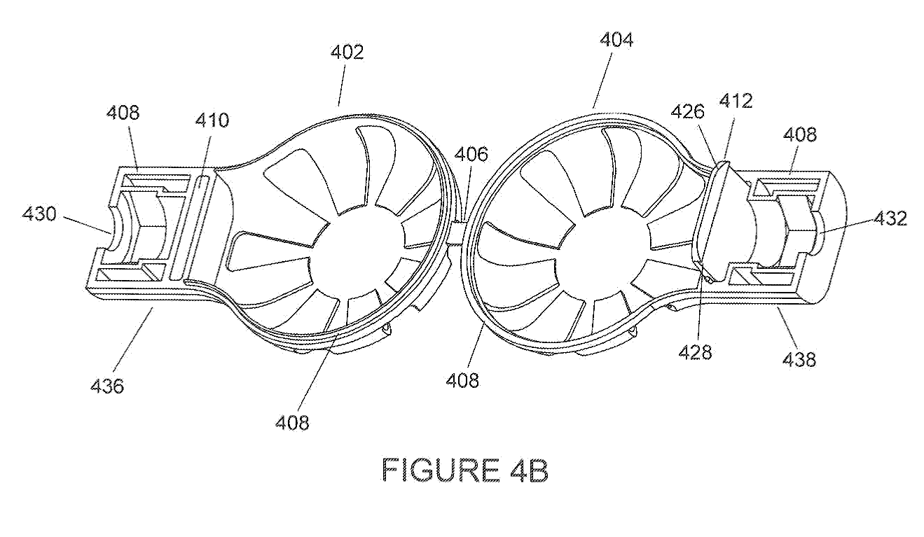

FIGS. 4A-B illustrate an unassembled flagpole-grasping device, that represents one embodiment of the present invention. The flagpole-grasping device is shown, in FIGS. 4A-B, in an initial unassembled form. The flagpole-grasping device 400 includes two, complementary half-shell components 402 and 404 joined by a flexible stem 406. The two half-shell components are generally related by mirror symmetry with respect to the planar mating surfaces 408 (obscured in FIG. 4A but visible in FIG. 4B) along which the two components mate with one another when the two components are folded together during assembly. However, the first component 402 includes a slot 410 into which a tab 412, approximately orthogonal to the mating plane 408 of the second component 404, is inserted during assembly of the flagpole-grasping device. Assembly is carried out by bending the stem 406 and folding the two half-shell components together, inserting tab 412 into slot 410 from below the mating plane of component 402.

Each half-shell component features a raised, central aperture 420 and 422 with a circular circumference partially inscribed by the ends of a number of bent, flexible, radial, tapered tines or prongs, such as prong 424 of component 404. The tines, or prongs, of a top half-shell component, when the assembled flagpole-grasping device is lying on the ground, bend inward, upon insertion of a golf-club handle into the top aperture, and grasp the end of the golf club while the prongs of the complementary half-shell component resist insertion of the golf-club handle into the bottom aperture of the flagpole-grasping device and thrusting of the golf-club handle into the green. Either aperture 420 and 422 may serve as the golf-club-handle entry point, depending on the orientation of the flagpole-grasping device with respect to the ground. FIG. 4B shows the unassembled flagpole-grasping device that represents one embodiment of the present invention inverted, with respect to the mating plane 408, from the orientation shown in FIG. 4A. In FIG. 4B, the tab 412 that is inserted into slot 410 during assembly of the flagpole-grasping device is more clearly visible. Note that the tab includes a slightly wedge-shaped nose 426 with a ledge 428 approximately parallel to the mating plane of the second component 408 that, when inserted into slot 410, is pushed above the outer surface of the first component to hold the two components together.

In certain embodiments of the present invention, a hole in the assembled flagpole-grasping device formed by semi-circular openings 430 and 432 in the ends of the half-shell components 402 and 404, respectively, is sized and, in certain cases, threaded or partially threaded to adapt the assembled flagpole-grasping device to a standard threaded fastener commonly found at the end of golf course flagpoles. In alternative embodiments, threading may additionally be implemented in semi-cylindrical interiors of the handle-like end portions 436 and 438 of the first and second half-shell-like components 402 and 404. In yet additional embodiments of the present invention, flexible prongs, tines, or tabs may be formed within the interior of the handle-like portions 436 and 438 of the half-shell-like components 402 and 404 to mechanically grasp an inserted flagpole end. In still additional embodiments, the hole may be sized to adapt the flagpole-grasping device for fastening to the flagpole by various fastening devices, including threaded fastening devices.

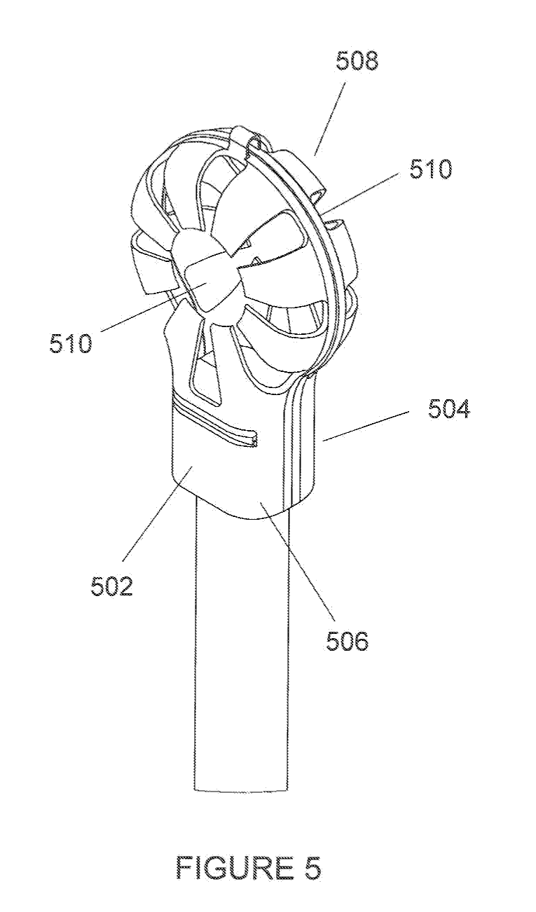

FIG. 5 shows an assembled flagpole-grasping device that represents one embodiment of the present invention, shown in unassembled form in FIGS. 4A-B, affixed to the end of a golf course flagpole. Note that a relatively flat surface 502 and 504 on either side of the mounting component 506 of the flagpole-grasping device may be used as a substrate for a reflective tape, patch, or paint so that the flagpole-grasping device can facilitate laser range finding. The two half-shell components adjoin along their mating surfaces to form an ellipsoid or flattened-spherical basket 508 with a central cylindrical aperture 510, comprising the apertures of the two half-shell components (420 and 422 in FIG. 4A), which constitutes a grasping component of the assembled flagpole-grasping device, as well as to form the mounting component 506 that affixes the grasping component to the end of the flagpole. The assembled flagpole-grasping device is made from a sufficiently flexible material that, when a flagpole, to which the flagpole-grasping device is attached, is dropped onto the surface of a green, the flagpole-grasping device bends and/or deforms, rather than deforming or otherwise harming the surface of the green.

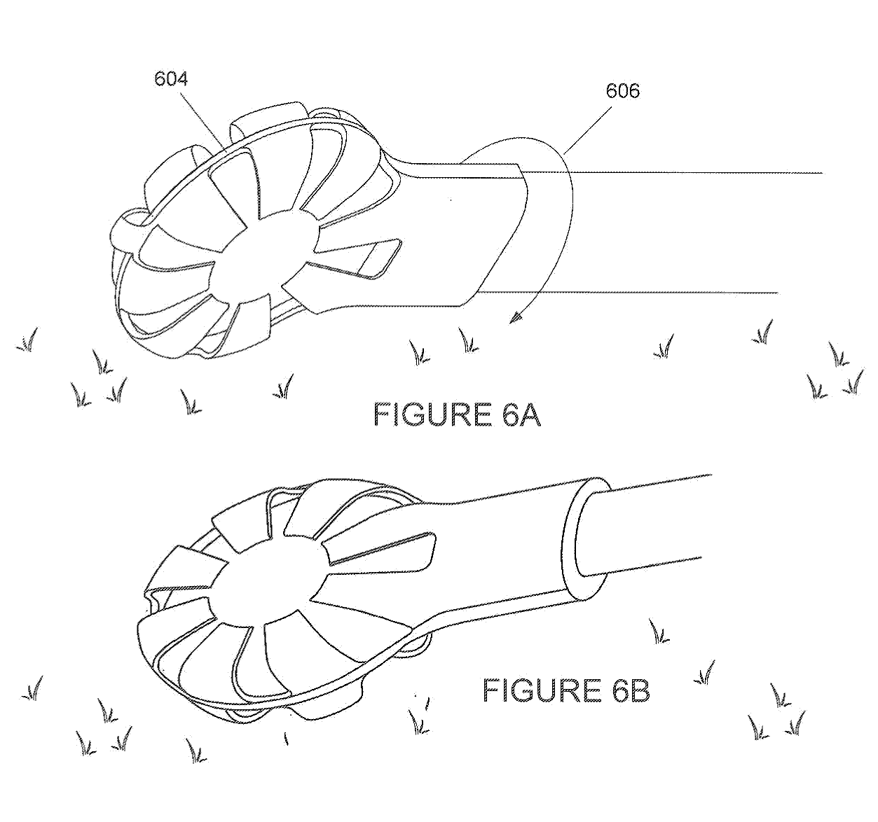

FIGS. 6A-B illustrate the self-orienting property of the flagpole-grasping device that represents one embodiment of the present invention. In FIG. 6A, a golf-course flagpole, to the end of which a flagpole-grasping device that represents one embodiment of the present invention is affixed, has been laid onto a golf green, with the circular edge of the flagpole-grasping device 604 placed into the grass of the green and the mating plane, along which the two half-shell components are joined, at an angle of between 60° and 90° with respect to the surface of the green. As indicated by curved arrow 606 in FIG. 6A, when the flagpole-grasping device is oriented, as shown in FIG. 6A, the flagpole and attached flagpole-grasping device will spontaneously roll to leave the flagpole-grasping device oriented so that the mating surface between the two half-shell-like components is approximately parallel with the surface of the green, as shown in FIG. 6B. In essence, only the orientation shown in FIG. 6B, or an opposite orientation in which the positions of the two half-shell components are interchanged, arc stable under the force of gravity.

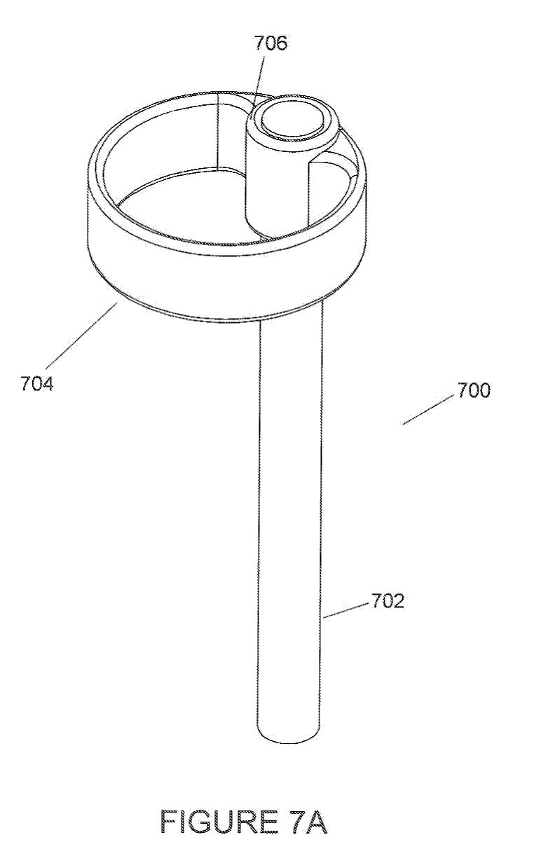

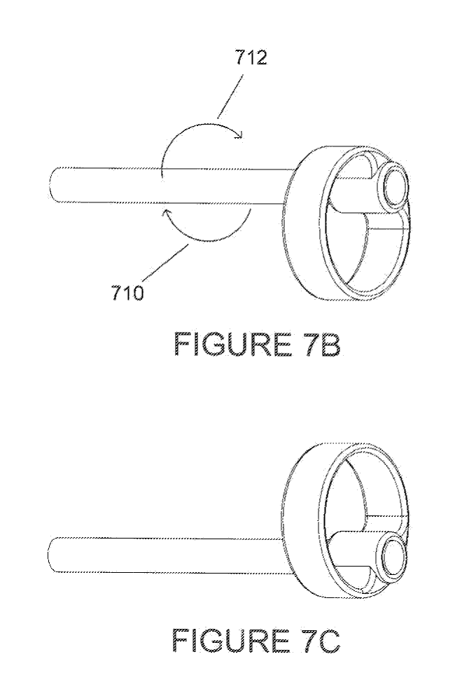

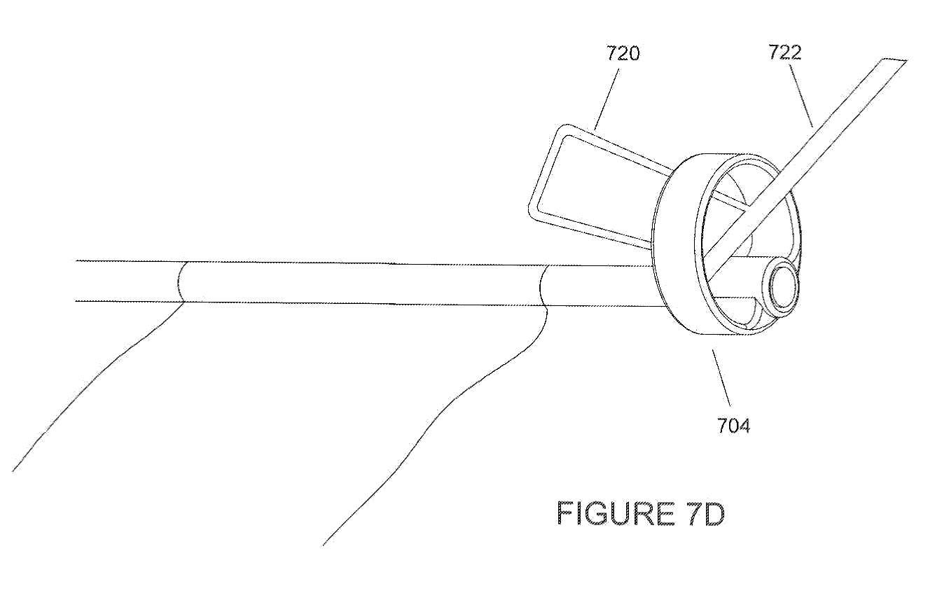

FIG. 7A shows an alternative flagpole-grasping device that represents a second embodiment of the present invention. The flagpole-grasping device as shown in FIG. 7A 700 includes a hollow cylindrical shaft 702 that mounts over the end of a flagpole and a flattened ring 704, or cylindrical section, onto the interior side of which the hollow shaft 702 is mounted. The cylindrical shaft may have internal threading complementary to threading at the end of golf-course flagpoles. The ring and shaft may be separately manufactured, and the shaft inserted into a cylindrical receptacle 706 formed at an interior edge of the ring, or may be molded as a single piece. FIGS. 7B-C illustrate the self-orienting properties of the flagpole-grasping device that represents a second embodiment of the present invention. In any orientation in which the hollow shaft and attached flagpole is not flush with the surface of the green, as shown in FIG. 7B, the flagpole-grasping device rotates, as indicated by curved arrows 710 and 712, to an orientation, shown in FIG. 7C, in which the hollow shaft and attached flagpole are flush with the green. As shown in FIG. 7D, the club portion 720 of a putter or other golf club 722 can be inserted through the ring 704 to grasp the flagpole-grasping device and lift the flagpole-grasping device along with the attached flagpole by lifting the putter or other golf club. Thus, the flattened ring, or cylindrical section 704 constitutes a grasping component and the hollow cylindrical shaft 702 constitutes a mounting component of the alternative flagpole-grasping device that represents a second embodiment of the present invention.

Although the present invention has been described in terms of particular embodiments, it is not intended that the invention be limited to these embodiments. Modifications will be apparent to those skilled in the art. For example, the flagpole-grasping devices may be manufactured from moldable plastic polymers, ductile and flexible metals, flexible composite materials, rubber, or any of many other durable, flexible, and moldable or machineable substances. The dimensions of the flagpole-grasping devices may vary, under the constraints that apertures for receiving golf-club handles or golf-club clubs are of appropriate size to receive and, in certain cases, grasp inserted golf-club handle or club. As discussed above, the ends or shafts of the flagpole-grasping devices may include apertures or threaded apertures complementary to standard threading commonly found at the end of flagpoles, or may be otherwise formed in order to securely mount to the ends of flagpoles. The flagpole-retrievable devices that represent embodiments of the present invention are manufactured to have sufficient flexibility or deformability that, when attached to a flagpole and dropped onto a green, the impact results in deforming, bending, or other change in the flagpole-retrievable devices rather than damage to the surface of the green.

The foregoing description, for purposes of explanation, used specific nomenclature to provide a thorough understanding of the invention. However, it will be apparent to one skilled in the art that the specific details are not required in order to practice the invention. The foregoing descriptions of specific embodiments of the present invention are presented for purpose of illustration and description. They are not intended to be exhaustive or to limit the invention to the precise forms disclosed. Many modifications and variations are possible in view of the above teachings. The embodiments are shown and described in order to best explain the principles of the invention and its practical applications, to thereby enable others skilled in the art to best utilize the invention and various embodiments with various modifications as are suited to the particular use contemplated. It is intended that the scope of the invention be defined by the following claims and their equivalents:

1. A self-orienting flagpole-grasping device comprising:
a mounting component that attaches the flagpole-grasping device to the end of a flagpole; and
a grasping component that grasps an end of a golf club inserted into the grasping component to allow the flagpole and attached flagpole-grasping device to be raised by raising the golf club or lowered by lowering the golf club.

2. The self-orienting flagpole-grasping device of claim 1 wherein the flagpole-grasping device is sufficiently flexible or deformable that, when the flagpole and attached flagpole-grasping device is dropped by a golf player onto a golf green, the flagpole-grasping device bends or deforms instead of harming the surface of the golf green.

3. The self-orienting flagpole-grasping device of claim 1 wherein the mounting component includes a threaded aperture complementary to standard threading formed at the end of the flagpole.

4. The self-orienting flagpole-grasping device of claim 1 wherein the mounting component includes a cylindrical chamber with interior threading complementary to standard threading formed at the end of the flagpole.

5. The self-orienting flagpole-grasping device of claim 1 wherein the mounting component includes interior grasping features that allow the flagpole-grasping device to be securely mounted to the end of a flagpole.

6. The self-orienting flagpole-grasping device of claim 1 further including a reflective coating or surface that reflects light from a laser range-finding device.

7. The self-orienting flagpole-grasping device of claim 1 wherein the grasping component is an ellipsoid or flattened-spherical basket with cylindrical aperture and the mounting component is a flattened cylindrical handle, both the grasping component and mounting component assembled by folding two half-shell components joined by a stem together to mate along mating planes of the two half-shell components.

8. The self-orienting flagpole-grasping device of claim 1 wherein the grasping component is a flattened ring or cylindrical section and the mounting component is a hollow cylindrical shaft mounted to an interior surface of the flattened ring or cylindrical section.
